(19) United States
(12) Patent Application Publication
(10) Pub. No.: US 2024/0349322 A1
(43) Pub. Date: Oct. 17, 2024

(54) COMMUNICATION SYSTEM AND COMMUNICATION METHOD

(71) Applicant: NIPPON TELEGRAPH AND TELEPHONE CORPORATION, Tokyo (JP)

(72) Inventors: Keita KURIYAMA, Musashino-shi, Tokyo (JP); Hayato FUKUZONO, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/294,162

(22) PCT Filed: Aug. 4, 2021
(86) PCT No.: PCT/JP2021/029025

§ 371 Date: Feb. 1, 2024

(51) Int. Cl. H04W 72/542; H04W 72/04

(52) U.S. Cl. CPC H04W 72/542; H04W 72/04

(57) ABSTRACT

A communication system capable of continuing communication even when the communication quality of a specific wireless channel is poor, with wireless channels used by each set of station apparatuses fixed. The communication system includes a first line switching apparatus that switches a first communication line connected to a first station apparatus, a second line switching apparatus that switches a second communication line connected to a second station apparatus, and a wireless channel allocation means that performs allocation from among a plurality of wireless communication channels to communication between the first communication line and the second communication line. The first line switching apparatus transmits, to the second line switching apparatus, a port number signal indicating a port number at which a signal is input from the first communication line to the first line switching apparatus. The second line switching apparatus specifies the port number of the second line switching apparatus.

### TECHNICAL FIELD

The present disclosure relates to a communication system and a communication method.

### BACKGROUND ART

A communication system and a communication method using base station antennas that can be shared with a plurality of frequency bands are known (see, for example, NPL 1). Further, an antenna duplexer or the like is used so that it is possible not only to share a single antenna with a plurality of frequency bands, but also to share the single antenna in a plurality of station apparatuses such as base stations and subscriber stations to operate a plurality of sets of station apparatuses or a plurality of wireless channels in parallel.

### CITATION LIST

### Non Patent Literature

NPL 1: Development of 5-frequency shared base station antenna for introduction of 700 MHz band, Tatsuhiko Yoshihara, Hiroyuki Kawai, Taisuke Ihara, NTT DoComo Technical Journal Vol 22 No 1, Apr. 1, 2014, p. 26-31

### SUMMARY OF INVENTION

### Technical Problem

Thus, in related art of a communication system and a communication method, an antenna duplexer or the like is used so that signals of a plurality of channels can be communicated between a plurality of sets of station apparatuses via a single antenna. However, in the related art, the wireless channel used by each set of station apparatuses is fixed and difficult to change. Therefore, when the communication quality of a specific wireless channel is poor, communication using the wireless channel needs to continue with the degraded quality. Alternatively, there is a likelihood that the number of lines in which simultaneous communication is possible in the wireless channel will decrease, and lines in which communication is not possible will occur.

The present disclosure has been made to solve such problems. An object of the present disclosure is to provide a communication system and a communication method capable of continuing communication with good quality even when the wireless communication quality of a specific wireless channel is poor, with wireless channels used by each set of station apparatuses fixed, and suppressing occurrence of lines disabled for communication.

### Solution to Problem

A communication system according to the present disclosure is a communication system including a first station apparatus configured to accommodate a plurality of first communication lines, and a second station apparatus configured to accommodate a plurality of second communication lines, and performing communication via a plurality of wireless communication channels between the first station apparatus and the second station apparatus, the communication system including: a first line switching apparatus configured to switch the first communication line connected to the first station apparatus; a second line switching apparatus configured to switch the second communication line connected to the second station apparatus; and a wireless channel allocation means configured to perform allocation from among a plurality of wireless communication channels to communication between the first communication line and the second communication line, wherein the first line switching apparatus transmits, to the second line switching apparatus, a port number signal indicating a port number at which a signal is input from the first communication line to the first line switching apparatus, the second line switching apparatus specifies the port number of the second line switching apparatus to be connected to the port number of the first line switching apparatus indicated by the port number signal, and the first line switching apparatus and the second line switching apparatus switch between the first communication line connected to the first station apparatus and the second communication line connected to the second station apparatus so that communication via the wireless communication channel allocated by the wireless channel allocation means is performed between the port number of the first line switching apparatus indicated by the port number signal and the port number of the second line switching apparatus specified by the second line switching apparatus.

A communication system according to the present disclosure is a communication method for performing communication between a first station apparatus and a second station apparatus over a plurality of wireless communication channels in a communication system including the first station apparatus configured to accommodate a plurality of first communication lines, the second station apparatus configured to accommodate a plurality of second communication lines, a first line switching apparatus configured to switch the first communication line connected to the first station apparatus, and a second line switching apparatus configured to switch the second communication line connected to the second station apparatus, the communication method including: a step of transmitting, by the first line switching apparatus, to the second line switching apparatus, a port number signal indicating a port number at which a signal is input from the first communication line to the first line switching apparatus; a step of specifying, by the second line switching apparatus, the port number of the second line switching apparatus to be connected to the port number of the first line switching apparatus indicated by the port number signal; an allocation step of performing allocation from among a plurality of wireless communication channels to communication between the first communication line and the second communication line; and a step of switching, by the first line switching apparatus and the second line switching apparatus, between the first communication line connected to the first station apparatus and the second communication line connected to the second station apparatus so that communication via the wireless communication channel allocated in the allocation step is performed between the port number of the first line switching apparatus indicated by the port number signal and the port number of the second line switching apparatus specified by the second line switching apparatus.

### Advantageous Effects of Invention

With the communication system and the communication method according to the present disclosure, it is possible to continue communication with good quality even when the wireless communication quality of a specific wireless channel is poor, with wireless channels used by each set of station apparatuses fixed, and suppress occurrence of lines disabled for communication.

### BRIEF DESCRIPTION OF DRAWINGS

FIG. 1 is a diagram schematically illustrating a configuration of a communication system according to Embodiment 1.

FIG. 2 is a block diagram illustrating a configuration of the communication system according to Embodiment 1.

FIG. 3 is a block diagram illustrating a configuration of a communication system of a comparative example.

FIG. 4 is a flowchart illustrating examples of an operation of the communication system according to Embodiment 1 and a communication method.

### DESCRIPTION OF EMBODIMENTS

Embodiments for implementing a communication system and a communication method according to the present disclosure will be described with reference to the accompanying drawings. In each figure, the same or corresponding parts are denoted by the same reference signs, and overlapping descriptions will be appropriately simplified or omitted. In the following description, for the sake of convenience, a positional relationship between respective structures may be expressed on the basis of the illustrated state. The present disclosure is not limited to the following embodiments, and any combination of the respective embodiments, any modification of components of the respective embodiments, or omission of any component of the respective embodiments can be made without departing from the spirit of the present disclosure.

### Embodiment 1

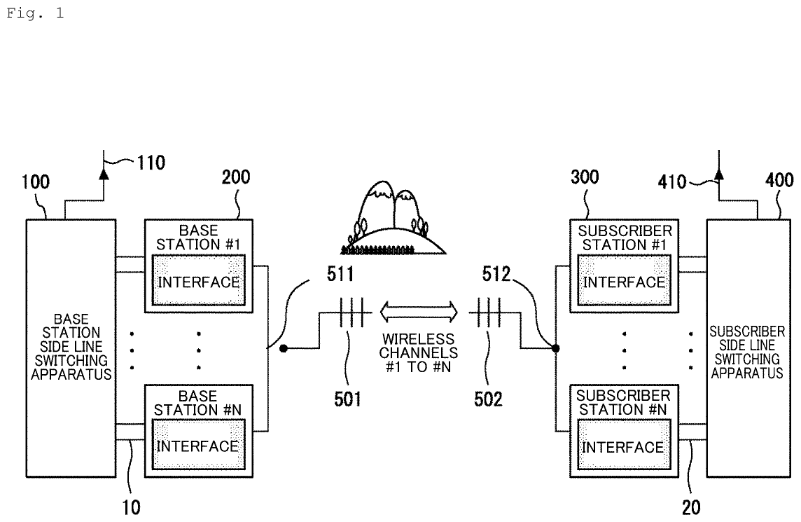

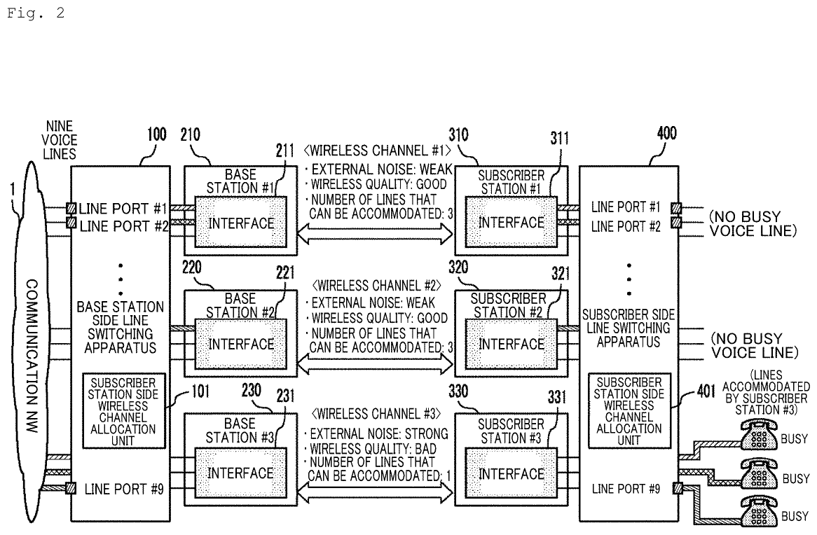

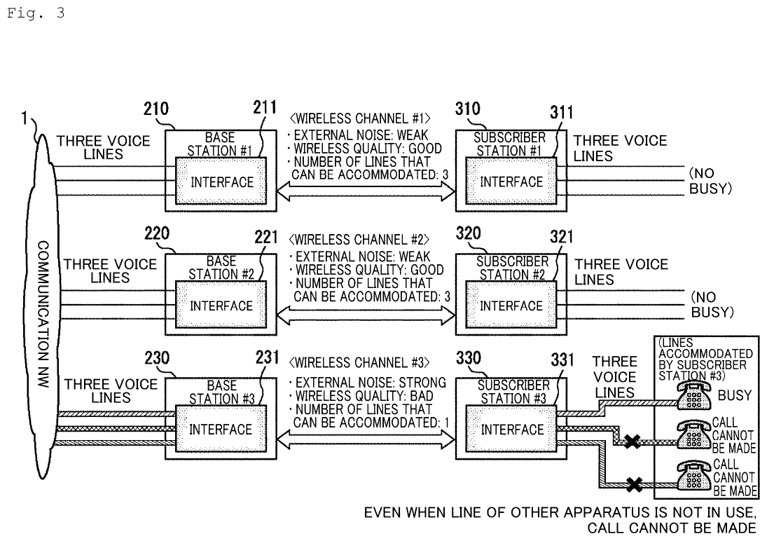

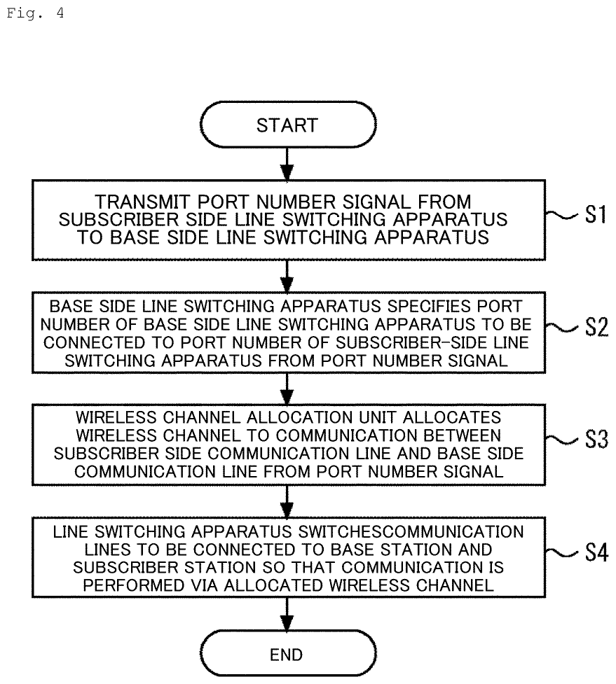

Embodiment 1 of the present disclosure will be described with reference to FIGS. 1 to 4. FIG. 1 is a diagram schematically illustrating a configuration of a communication system. FIG. 2 is a block diagram illustrating the configuration of a communication system. FIG. 3 is a block diagram illustrating a configuration of a communication system of a comparative example. FIG. 4 is a flowchart illustrating examples of an operation of the communication system and a communication method.

The communication system according to the present embodiment performs communication between a plurality of base stations 200 and a plurality of subscriber stations 300, as illustrated in FIG. 1. In a configuration example described here, the number of subscriber stations 300 and the number of base stations 200 in the communication system are equal to each other. The subscriber station 300 is an example of a first station apparatus. The base station 200 is an example of a second station apparatus. A plurality of subscriber station side communication lines 20 are accommodated in the subscriber station 300, which is the first station apparatus. A plurality of base station side communication lines 10 are accommodated in the base station 200, which is the second station apparatus. The subscriber station side communication line 20 is an example of a first communication line. The base station side communication line 10 is an example of a second communication line.

The subscriber station side communication line 20 and the base station side communication line 10 are, for example, voice communication lines. When the subscriber station side communication line 20 and the base station side communication line 10 are voice communication lines, analog signals flow through these communication lines. The subscriber station side communication line 20 and the base station side communication line 10 are not limited to voice communication lines, and may be, for example, digital data communication lines.

Communication between the subscriber station 300, which is the first station apparatus, and the base station 200, which is the second station apparatus, is wireless communication via an antenna. The plurality of base stations 200 are connected to one base station side antenna 501 via a base station side antenna duplexer 511. The plurality of subscriber stations 300 are connected to one subscriber station side antenna 502 via a subscriber station side antenna duplexer 512.

The subscriber station 300 and the base station 200 communicate via a plurality of wireless channels. In a configuration example described here, the number of subscriber stations 300 and the number of base stations 200 in the communication system are equal to each other. The number of wireless channels used for communication between the subscriber stations 300 and the base stations 200 is also the same as the number of subscriber stations 300 and the number of base stations 200. That is, each subscriber station 300 and each base station 200 are associated to form a set, and one wireless channel is prepared for each set of the subscriber station 300 and base station 200.

In the example illustrated in FIG. 1, N base stations 200 from a first base station to an N-th base station are provided. Further, N subscriber stations 300 from a first subscriber station to an N-th subscriber station are provided. Here, N is an integer equal to or greater than 2. The N-th base station and the N-th subscriber station communicate on an N-th wireless channel. That is, for example, the first base station and the first subscriber station communicate over a first wireless channel. In each figure of the present disclosure, “first”, “second”, . . . , “N-th” are indicated by “#1”, “#2”, . . . , “#N”, respectively. Thus, in the communication system according to the present embodiment, a plurality of sets of station apparatuses are operated in parallel using an antenna duplexer.

The communication system according to the present embodiment includes a subscriber station side line switching apparatus 400 and a base station side line switching apparatus 100. The subscriber station side line switching apparatus 400 is a first line switching apparatus that switches the subscriber station side communication line 20 connected to each subscriber station 300, which is the first station apparatus. The base station side line switching apparatus 100 is a second line switching apparatus that switches the base station side communication line 10 connected to each base station 200, which is the second station apparatus.

Next, a configuration example of the communication system according to the present embodiment will also be described with reference to FIG. 2. In the example illustrated in FIG. 2, three base stations including a first base station 210, a second base station 220, and a third base station 230 are provided as the base stations 200 for the sake of simplicity of description. Further, three subscriber stations including a first subscriber station 310, a second subscriber station 320, and a third subscriber station 330 are provided as the subscriber stations 300. The first base station 210 and the first subscriber station 310 communicate over the first wireless channel. The second base station 220 and the second subscriber station 320 communicate via a second wireless channel. The third base station 230 and the third subscriber station 330 communicate via a third wireless channel. Three base station side communication lines 10 are accommodated in each base station 200. Further, three subscriber station side communication lines 20 are accommodated in each subscriber station 300. That is, there are a total of nine subscriber station side communication lines 20 and a total of nine base station side communication lines 10.

The base station side line switching apparatus 100 is provided between the communication network 1 and each base station 200. The base station side line switching apparatus 100 includes connection ports on the communication network 1 side and the base station 200 side. The number of connection ports provided in the base station side line switching apparatus 100 is at least the number of second communication lines accommodated in the base station 200. In the illustrated example, the base station side line switching apparatus 100 includes nine connection ports on each of the communication network 1 side and the base station 200 side.

Each base station 200 includes an interface to which the accommodated base station side communication lines 10 are connected. That is, the first base station 210 includes a first base station interface 211. Three base station communication lines 10 accommodated in the first base station 210 are connected to the first base station interface 211 and respective ports of the base station side line switching apparatus 100 on the base station 200 side. The second base station 220 includes a second base station interface 221. Three base station communication lines 10 accommodated in the second base station 220 are connected to the second base station interface 221 and respective ports of the base station side line switching apparatus 100 on the base station 200 side. The third base station 230 includes a third base station interface 231. Three base station communication lines 10 accommodated in the third base station 230 are connected to the third base station interface 231 and respective ports of the base station side line switching apparatus 100 on the base station 200 side.

The subscriber station side line switching apparatus 400 is provided between each subscriber station 300 and each subscriber terminal (a telephone or the like). The subscriber station side line switching apparatus 400 includes a connection port on each of the subscriber station 300 side and the subscriber terminal side. The number of connection ports provided in the subscriber station side line switching apparatus 400 is at least the number of first communication lines accommodated in the subscriber station 300. In the illustrated example, the subscriber station side line switching apparatus 400 includes nine connection ports on each of the subscriber station 300 side and the subscriber terminal side.

Each subscriber station 300 includes an interface to which the accommodated subscriber station side communication line 20 is connected. That is, the first subscriber station 310 has a first subscriber station interface 311. The three subscriber station side communication lines 20 accommodated in the first subscriber station 310 are connected to the first subscriber station interface 311 and respective ports of the subscriber station side line switching apparatus 400 on the subscriber station 300 side. The second subscriber station 320 includes a second subscriber station interface 321. The three subscriber station side communication lines 20 accommodated in the second subscriber station 320 are connected to the second subscriber station interface 321 and respective ports of the subscriber station side line switching apparatus 400 on the subscriber station 300 side. The third subscriber station 330 includes a third subscriber station interface 331. The three subscriber station side communication lines 20 accommodated in the third subscriber station 330 are connected to the third subscriber station interface 331 and respective ports of the subscriber station side line switching apparatus 400 on the subscriber station 300 side.

In the communication system according to the present embodiment, the base station side line switching apparatus 100 includes a base station side wireless channel allocation unit 101. Further, the subscriber station side line switching apparatus 400 includes a subscriber station side wireless channel allocation unit 401. The base station side wireless channel allocation unit 101 and the subscriber station side wireless channel allocation unit 401 are wireless channel allocation means for allocating one wireless channel among the plurality of wireless channels described above to the communication between the subscriber station side communication line 20, which is the first communication line, and the base station side communication line 10, which is the second communication line.

This wireless channel allocation is performed on the basis of one or both of the number of lines that can be accommodated in the station apparatus, which correspond to the respective wireless channels, and the communication qualities of the respective wireless channels. The base station side wireless channel allocation unit 101 and the subscriber station side wireless channel allocation unit 401 evaluate the communication quality of the wireless channel using, for example, a signal-to-noise ratio (SNR). The base station side wireless channel allocation unit 101 and the subscriber station side wireless channel allocation unit 401 preferentially allocate wireless channels with relatively good communication quality. Alternatively, the base station side wireless channel allocation unit 101 and the subscriber station side wireless channel allocation unit 401 may preferentially allocate available wireless channels of station apparatuses to the number of lines that can be accommodated.

When communication quality is evaluated using the SNR, a base station side external noise acquisition antenna 110 may be provided in the base station side line switching apparatus 100, as illustrated in FIG. 1. Further, the subscriber station side line switching apparatus 400 may be provided with the subscriber station side external noise acquisition antenna 410. The base station side external noise acquisition antenna 110 and the subscriber station side external noise acquisition antenna 410 acquire external noise of the respective wireless channels. The base station side wireless channel allocation unit 101 calculates the SNR using the external noise acquired by the base station side external noise acquisition antenna 110. Similarly, the subscriber station side wireless channel allocation unit 401 calculates the SNR using the external noise acquired by the subscriber station side external noise acquisition antenna 410.

The base station side wireless channel allocation unit 101 may acquire the external noise from the base station side antenna 501 via the base station 200 or directly without using the base station side external noise acquisition antenna 110. Further, the subscriber station side wireless channel allocation unit 401 may acquire the external noise from the subscriber station side antenna 502 via the subscriber station 300 or directly without using the subscriber station side external noise acquisition antenna 410.

In the communication system configured as described above, when one of the subscriber terminals makes a call, a signal is input from the subscriber station side communication line 20 corresponding to the subscriber terminal to the subscriber station side line switching apparatus 400. When the signal is input from the subscriber station side communication line 20 to the subscriber station side line switching apparatus 400, the subscriber station side line switching apparatus 400 transmits, to the base station side line switching apparatus 100, a port number signal indicating a port number at which a signal is input from the subscriber station side communication line 20 to the subscriber station side line switching apparatus 400. That is, the first line switching apparatus transmits, to the second line switching apparatus, the port number signal indicating the port number at which the signal is input from the first communication line to the first line switching apparatus.

The base station side line switching apparatus 100 receives the port number signal transmitted from the subscriber station side line switching apparatus 400. The base station side line switching apparatus 100 specifies a port number of the base station side line switching apparatus 100 to be connected to the port number of the subscriber station side line switching apparatus 400 indicated by the received port number signal. That is, the second line switching apparatus specifies the port number of the second line switching apparatus to be connected to the port number of the first line switching apparatus indicated by the port number signal.

The subscriber station side line switching apparatus 400 and the base station side line switching apparatus 100 switch between the subscriber station side communication line 20 connected to the subscriber station 300 and the base station side communication line 10 connected to the base station 200 so that communication via the wireless channel allocated by the base station side wireless channel allocation unit 101 and the subscriber station side wireless channel allocation unit 401 is performed between the port number of the subscriber station side line switching apparatus 400 indicated by the port number signal and the port number of the base station side line switching apparatus 100 specified by the base station side line switching apparatus 100. That is, the first line switching apparatus and the second line switching apparatus switch between the first communication line connected to the first station apparatus and the second communication line connected to the second station apparatus so that communication via the wireless communication channel allocated by the wireless channel allocation means is performed between the port number of the first line switching apparatus indicated by the port number signal and the port number of the second line switching apparatus specified by the second line switching apparatus.

The allocation of the wireless channels and communication processing in the communication system configured as described above will be described with reference to a specific example illustrated in FIG. 2. First, the base station side wireless channel allocation unit 101 and the subscriber station side wireless channel allocation unit 401 acquire information on the SNR of each wireless channel and the number of lines that can be accommodated in each station apparatus from the base station 200, the subscriber station 300, the base station side external noise acquisition antenna 110, and the subscriber station side external noise acquisition antenna 410. The base station side wireless channel allocation unit 101 and the subscriber station side wireless channel allocation unit 401 sets allocation priorities for the respective wireless channels in descending order of a spare capacity, on the basis of the acquired information on the SNR of each wireless channel and the number of lines that can be accommodated in each station apparatus.

In the example illustrated in FIG. 2, the external noise of the first wireless channel is weak, the wireless communication quality thereof is good, and the number of lines that can be accommodated is three. External noise of the second wireless channel is also weak, the wireless communication quality thereof is good, and the number of lines that can be accommodated is three. In the third wireless channel, external noise is strong, and the wireless communication quality is poor. The number of lines that can be accommodated in the third wireless channel is reduced to one with the deterioration of the wireless communication quality. Therefore, the base station side wireless channel allocation unit 101 and the subscriber station side wireless channel allocation unit 401 set allocation priorities of the first wireless channel and the second wireless channel to “high”, and set an allocation priority of the third wireless channel to “low”.

It is assumed that an analog telephone signal (a dial pulse signal, push button signal, or the like) is input from the subscriber terminal to a seventh line port of the subscriber station side line switching apparatus 400. In this case, the subscriber station side line switching apparatus 400 adds a port number signal indicating the line port number at which input of a signal is detected to a head of an input signal. Here, as the port number signal, a dedicated pulse signal may be prepared, or a dial pulse signal or a push button signal may be used.

The subscriber station side line switching apparatus 400 transmits, to the base station side line switching apparatus 100, an analog telephone signal with the port number signal added to a head. The wireless channel allocated by the subscriber station side wireless channel allocation unit 401 is used for the transmission in this case. In the example described here, the allocation priorities of the first wireless channel and the second wireless channel are set to “high”, as described above. Therefore, for example, the subscriber station side wireless channel allocation unit 401 allocates the first wireless channel to the communication. Therefore, the subscriber station side line switching apparatus 400 outputs, to the first subscriber station 310, the analog telephone signal to which the port number signal is added. The analog telephone signal to which the port number signal is added is sent from the first subscriber station 310 to the base station side line switching apparatus 100 via the first wireless channel and the first base station 210.

The base station side line switching apparatus 100 extracts the port number signal from the received signal. The base station side line switching apparatus 100 first specifies the port number of the subscriber station side line switching apparatus 400 to which the analog telephone signal is input, from the extracted port number signal. Next, the base station side line switching apparatus 100 specifies the port number of the base station side line switching apparatus 100 to be connected to the port number of the subscriber station side line switching apparatus 400. In the example described here, the port number of the base station side line switching apparatus 100 corresponding to the port number of the subscriber station side line switching apparatus 400 is the same. Therefore, next, the base station side line switching apparatus 100 specifies a seventh line port of the base station side line switching apparatus 100 as the connection port, for the seventh line port of the subscriber station side line switching apparatus 400. The base station side line switching apparatus 100 removes the port number signal from the analog telephone signal to which the port number signal is added, and outputs the analog telephone signal from the specified seventh line port to the communication network 1.

Then, the subscriber station side line switching apparatus 400 and the base station side line switching apparatus 100 pass signals from the subscriber terminal and the communication network 1 so that communication via the first wireless channel can be performed between the seventh line ports of the subscriber station side line switching apparatus 400 and the base station side line switching apparatus 100. That is, the subscriber station side line switching apparatus 400 sets the seventh line port on the subscriber terminal side to a use state. The subscriber station side line switching apparatus 400 outputs, from a first line port on the subscriber station 300 side, a signal input from the seventh line port on the subscriber terminal side, and transmits the signal to the first subscriber station 310. The first subscriber station 310 transmits the input signal to the first base station 210 over the first wireless channel. The first base station 210 outputs the received signal to a first line port of base station side line switching apparatus 100 on the base station 200 side. The base station side line switching apparatus 100 sets the seventh line port on the communication network 1 side to a use state. The base station side line switching apparatus 100 outputs, from the seventh line port on the communication network 1 side, a signal input from the first line port on the base station 200 side. Signals transmitted from the communication network 1 to the subscriber terminal are similarly processed.

In this state, it is now assumed that an analog telephone signal is input from the subscriber terminal to an eighth line port of the subscriber station side line switching apparatus 400. Since the first wireless channel is used for communication of the seventh line port, the number of lines that can be accommodated in the first wireless channel is reduced to two, while the number of lines that can be accommodated in the second wireless channel remains three. Therefore, the subscriber station side wireless channel allocation unit 401 allocates the second wireless channel with a relatively large spare capacity to the communication.

Subsequent processing is the same as those in the example of the seventh line port described above. That is, the subscriber station side line switching apparatus 400 and the base station side line switching apparatus 100 pass signals from the subscriber terminal and the communication network 1 so that communication via the second wireless channel can be performed between the eighth line ports of the subscriber station side line switching apparatus 400 and the base station side line switching apparatus 100. More specifically, the subscriber station side line switching apparatus 400 sets the eighth line port on the subscriber terminal side to a use state. The subscriber station side line switching apparatus 400 outputs, from a fourth line port on the subscriber station 300 side, a signal input from the eighth line port on the subscriber terminal side, and transmits the signal to the second subscriber station 320, The second subscriber station 320 transmits the input signal to the second base station 220 over the second wireless channel. The second base station 220 outputs the received signal to the fourth line port of the base station side line switching apparatus 100 on the base station 200 side. The base station side line switching apparatus 100 sets the eighth line port on the communication network 1 side to a use state. The base station side line switching apparatus 100 outputs, from the eighth line port on the communication network 1 side, the signal input from the fourth line port on the base station 200 side. Signals to be transmitted from the communication network 1 to the subscriber terminal are similarly processed.

In this state, it is also assumed that an analog telephone signal is input from the subscriber terminal to a ninth line port of the subscriber station side line switching apparatus 400. At this point in time, the numbers of lines that can be accommodated in the first wireless channel and the second wireless channel are both two. Therefore, the subscriber station side wireless channel allocation unit 401 allocates, for example, the first wireless channel to the communication.

Subsequent processing is the same as those in the example of the seventh line port and the eighth line port described above. That is, the subscriber station side line switching apparatus 400 and the base station side line switching apparatus 100 pass signals from the subscriber terminal and the communication network 1 so that communication via the first wireless channel can be performed between ninth line ports of the subscriber station side line switching apparatus 400 and the base station side line switching apparatus 100. More specifically, the subscriber station side line switching apparatus 400 sets the ninth line port on the subscriber terminal side to a use state. The subscriber station side line switching apparatus 400 outputs, from the second line port on the subscriber station 300 side, the signal input from the ninth line port on the subscriber terminal side, and transmits the signal to the first subscriber station 310. The first subscriber station 310 transmits the input signal to the first base station 210 over the first wireless channel. The first base station 210 outputs the received signal to the second line port of the base station side line switching apparatus 100 on the base station 200 side. The base station side line switching apparatus 100 sets the ninth line port on the communication network 1 side to a use state. The base station side line switching apparatus 100 outputs, from the ninth line port on the communication network 1 side, the signal input from the second line port on the base station 200 side. Signals to be transmitted from the communication network 1 to the subscriber terminal are similarly processed.

Next, effects that can be achieved by the communication system according to the present embodiment will be described further with reference to the comparative example in FIG. 3. The system illustrated in the comparative example in FIG. 3 does not include the base station side line switching apparatus 100 and the subscriber station side line switching apparatus 400 according to the present disclosure. That is, in the comparative example of FIG. 3, the base station side communication line 10 is directly connected to each base station 200, and the subscriber station side communication line 20 is directly connected to each subscriber station 300. As described above, one wireless channel is provided for each set of subscriber station 300 and base station 200. The wireless channel used by each set of subscriber station 300 and base station 200 is fixed and cannot be changed. In such a comparative example, when communication is simultaneously performed in the three lines accommodated in the third subscriber station 330, all of the three lines use the third wireless channel. Therefore, when there is strong external noise in the third wireless channel and the wireless communication quality is poor, the communication should be continued with the quality degraded, or the number of lines in which simultaneous communication is possible decreases and lines in which communication is not possible may occur.

On the other hand, the communication system according to the present embodiment includes the base station side line switching apparatus 100 and the subscriber station side line switching apparatus 400, as described above, and includes a wireless channel allocation means for allocating one of a plurality of wireless communication channels to communication between the base station side communication line 10 and the subscriber station side communication line 20. Switching is performed between the subscriber station side communication line 20 connected to the subscriber station 300 and the base station side communication line 10 connected to the base station 200 so that information on the port number of the line to be connected is exchanged between the base station side line switching apparatus 100 and the subscriber station side line switching apparatus 400, and communication via the wireless channel allocated by the wireless channel allocation means is performed, making it possible to change the wireless communication channel to be used for communication between the base station side communication line 10 on the communication network 1 side and the subscriber station side communication line 20 on the subscriber terminal side, with a wireless channel to be used by each set of the subscriber station 300 and the base station 200 fixed. Therefore, with the communication system according to the present embodiment, when there is strong external noise in a specific wireless channel and the wireless communication quality is poor, it is possible to continue communication with good quality using another wireless channel, and suppress occurrence of lines disabled for communication.

In the communication system according to the present embodiment, the communication quality of the wireless channel may be monitored during communication between the base station side communication line 10 and the subscriber station side communication line 20. The base station side wireless channel allocation unit 101 and the subscriber station side wireless channel allocation unit 401 may change wireless channels to be allocated to the base station side communication line 10 and the subscriber station side communication line 20 that are performing communication, as necessary. In this case, the base station side line switching apparatus 100 and the subscriber station side line switching apparatus 400 switches between the subscriber station side communication line 20 connected to the subscriber station 300 and the base station side communication line 10 connected to the base station 200 so that communication via the wireless channel whose allocation has been changed is performed.

When the allocated wireless channel is changed during communication, one of the base station side line switching apparatus 100 and the subscriber station side line switching apparatus 400 (hereinafter also referred to as “one line switching apparatus”) transmits the above-described port number signal to the other of the base station side line switching apparatus 100 and the subscriber station side line switching apparatus 400 (hereinafter also referred to as “the other line switching apparatus”). The other line switching apparatus receives the port number signal transmitted from the one line switching apparatus. The other line switching apparatus specifies the port number of the other line switching apparatus to be connected to the port number of the one line switching apparatus indicated by the received port number signal. When the specified port number is already in use, the wireless channel to be used for communication of the port number in use is changed.

Here, two cases for transmission of the port number signal at the time of changing of the wireless channel to be allocated during communication, including a case in which the wireless channel after change is used and a case in which the wireless channel before change is used are conceivable. In a case in which the wireless channel after change is used, the other line switching apparatus switches the wireless channel to be used for communication of the port number in use to a wireless channel of the station apparatus used at the time of input of the port number signal to the other line switching apparatus, when the port number specified from the received port number signal is in use.

Further, when the wireless channel before change is used, the one line switching apparatus transmits a station apparatus port signal indicating an input and output port of the station apparatus corresponding to the wireless channel after change, in addition to the above-described port number signal, to the other line switching apparatus. When the other line switching apparatus receives the station apparatus port signal, the other line switching apparatus changes the wireless channel to be used for communication of the port number specified from the received port number signal, to a wireless channel indicated by the station apparatus port signal. In this case, for example, it is conceivable to add the port number signal to the head of the analog telephone signal and add the station apparatus port signal to an end of the analog telephone signal.

Next, a communication method according to the present embodiment will be described with reference to a flowchart of FIG. 4. The communication method according to the present embodiment is a communication method for performing communication between the base station 200 and the subscriber station 300 via a plurality of wireless communication channels in the communication system configured as described above. That is, the communication method according to the present embodiment is a communication method for performing communication between a first station apparatus and a second station apparatus over a plurality of wireless communication channels in a communication system including the first station apparatus that accommodates a plurality of first communication lines, the second station apparatus that accommodates a plurality of second communication lines, a first line switching apparatus that switches the first communication line connected to the first station apparatus, and a second line switching apparatus that switches the second communication line connected to the second station apparatus.

In the communication method according to the present embodiment, first, the subscriber station side line switching apparatus 400, which is a first line switching apparatus, transmits the port number signal to the base station side line switching apparatus 100, which is the second line switching apparatus, in step S1. The port number signal is a signal indicating the port number at which a signal is input from the subscriber station side communication line 20, which is the first communication line, to the subscriber station side line switching apparatus 400. In subsequent step S2, the base station side line switching apparatus 100, which is the second line switching apparatus, specifies the port number of the base station side line switching apparatus 100 connected to the port number of the subscriber station side line switching apparatus 400 indicated by the received port number signal.

In step S3, an allocation step for allocating one of the plurality of wireless communication channels to communication between the subscriber station side communication line 20, which is the first communication line, and the base station side communication line 10, which is the second communication line, is performed. In this allocation step, for example, the base station side wireless channel allocation unit 101 and the subscriber station side wireless channel allocation unit 401, which are wireless channel allocation means, set the allocation priority of the wireless channel on the basis of one or both of the number of lines that can be accommodated in the station apparatus, which correspond to the respective wireless channels, and the communication qualities of the respective wireless channels. The base station side wireless channel allocation unit 101 and the subscriber station side wireless channel allocation unit 401 perform allocation of wireless channels according to the set allocation priority.

In step S4, the subscriber station side line switching apparatus 400 and the base station side line switching apparatus 100 switch between the subscriber station side communication line 20 connected to the subscriber station 300 and the base station side communication line 10 connected to the base station 200, so that communication via the wireless channel allocated in step S3 is performed between the port number of the subscriber station side line switching apparatus 400 indicated by the port number signal of step S1 and the port number of the base station side line switching apparatus 100 specified in step S2.

Although step S2 is executed after step S1, step S3 may be executed before step S1 and step S2, after step S1 and step S2, or between step S1 and step S2. Further, step S4 is executed after all of steps S1 to S3 are executed.

In the communication method configured as described above, it is possible to obtain the same effects as those of the communication system according to the present embodiment.

A case in which the subscriber station 300 is the first station apparatus, the subscriber station side line switching apparatus 400 is the first line switching apparatus, the subscriber station side communication line 20 is the first communication line, the base station 200 is the second station apparatus, the base station side line switching apparatus 100 is the second line switching apparatus, and the base station side communication line 10 is the second communication line has been described above. However, these relationships may be reversed. That is, in the communication system and the communication method according to the present disclosure, the base station 200 may be the first station apparatus, the base station side line switching apparatus 100 may be the first line switching apparatus, the base station side communication line 10 may be the first communication line, the subscriber station 300 may be the second station apparatus, the subscriber station side line switching apparatus 400 may be the second line switching apparatus, and the subscriber station side communication line 20 may be the second communication line.

Further, in the communication system and the communication method according to the present embodiment, control circuits of the base station side line switching apparatus 100 and the subscriber station side line switching apparatus 400 may include, for example, a computer including a processor and a memory (not illustrated). In this case, the communication system executes preset processing by the processor of the computer executing a program stored in the memory of the computer, to control the communication system and execute the communication method.

In other words, the communication system and the communication method according to the present disclosure can also be realized by the processor executing the program stored in the memory to perform preset processing and cause hardware and software to work together. A program for realizing the system and method according to the present disclosure can be recorded on an information recording medium. Further, the program for realizing the system and method according to the present disclosure can also be provided through a communication network.

### INDUSTRIAL APPLICABILITY

The present disclosure can be used for a communication system including a first station apparatus that accommodates a plurality of first communication lines, and a second station apparatus that accommodates a plurality of second communication lines, and performing communication via a plurality of wireless communication channels between the first station apparatus and the second station apparatus, and a communication method for the communication system.

### REFERENCE SIGNS LIST

1 Communication network
10 Base station side communication line
20 Subscriber station side communication line
100 Base station side line switching apparatus
101 Base station side wireless channel allocation unit
110 Base station side external noise acquisition antenna
200 Base station
210 First base station
211 First base station interface
220 Second base station
221 Second base station interface
230 Third base station
231 Third base station interface
300 Subscriber station
310 First subscriber station
311 First subscriber station interface
320 Second subscriber station
321 Second subscriber station interface
330 Third subscriber station
331 Third subscriber station interface
400 Subscriber station side line switching apparatus
401 Subscriber station side wireless channel allocation unit
410 Subscriber station side external noise acquisition antenna
501 Base station side antenna
502 Subscriber station side antenna
511 Base station side antenna duplexer
512 Subscriber station side antenna duplexer

1. A communication system including
a first station to accommodate a plurality of first communication lines, and
a second station to accommodate a plurality of second communication lines,
and performing communication via a plurality of wireless communication channels between the first station and the second station, the communication system comprising:
a first line switch to switch the first communication line connected to the first station;
a second line switch to switch the second communication line connected to the second station; and
wireless channel allocation circuitry configured to perform allocation from among a plurality of wireless communication channels to communication between the first communication line and the second communication line,
wherein the first line switch transmits, to the second line switch, a port number signal indicating a port number at which a signal is input from the first communication line to the first line switch,
the second line switch specifies the port number of the second line switch to be connected to the port number of the first line switch indicated by the port number signal, and
the first line switch and the second line switch switch between the first communication line connected to the first station and the second communication line connected to the second station so that communication via the wireless communication channel allocated by the wireless channel allocation circuitry is performed between the port number of the first line switch indicated by the port number signal and the port number of the second line switch specified by the second line switch.

2. The communication system according to claim 1, wherein:
the wireless channel allocation circuitry allocates the wireless communication channel on the basis of one or both of the number of lines that can be accommodated in the first station and the second station corresponding to the wireless communication channel and the communication quality of the wireless communication channel.

3. A communication method for performing communication between a first station and a second station over a plurality of wireless communication channels in a communication system including the first station configured to accommodate a plurality of first communication lines,
the second station configured to accommodate a plurality of second communication lines,
a first line switch configured to switch the first communication line connected to the first station, and
a second line switch configured to switch the second communication line connected to the second station, the communication method comprising:
transmitting, by the first line switch, to the second line switch, a port number signal indicating a port number at which a signal is input from the first communication line to the first line switch;
specifying, by the second line switch, the port number of the second line switch to be connected to the port number of the first line switch indicated by the port number signal;
performing allocation from among a plurality of wireless communication channels to communication between the first communication line and the second communication line; and
switching, by the first line switch and the second line switch, between the first communication line connected to the first station and the second communication line connected to the second station so that communication via the wireless communication channel allocated in the allocation step is performed between the port number of the first line switch indicated by the port number signal and the port number of the second line switch specified by the second line switch.

4. The communication method according to claim 3, wherein the performing allocation includes:
allocating the wireless communication channel on the basis of one or both of the number of lines that can be accommodated in the first station and the second station corresponding to the wireless communication channel and the communication quality of the wireless communication channel.
